(19) United States
(12) Patent Application Publication
(10) Pub. No.: US 2008/0046751 A1
(43) Pub. Date: Feb. 21, 2008

(54) SYSTEM, APPARATUS AND METHOD FOR PROVIDING DATA SECURITY USING USB DEVICE

(75) Inventor: In Chul Choi, Seongnam (KR)

Correspondence Address: RABIN & Berdo, PC, 1101 14TH STREET, NW, SUITE 500, WASHINGTON, DC, 20005, US

(73) Assignee: ADVANCED DIGITAL CHIPS INC., Seoul (KR)

(21) Appl. No.: 11/534,284

(22) Filed: Sep. 22, 2006

(30) Foreign Application Priority Data
Aug. 14, 2006 (KR) 10-2006-0076641

(51) Int. Cl. H04L 9/00

(52) U.S. Cl. 713/185

(57) ABSTRACT

Disclosed is a data security system using a USB device for maintaining security for files made while various kinds of application programs are used. The data security system comprises: a local computer having the various kinds of application programs installed therein and performing various works by executing the installed various kinds of application programs; and a USB device connected to the local computer via a USB communicating means, wherein, when the USB device is connected to the local computer, a security program is automatically installed from the USB device into the local computer, and the automatically-installed security program performs a security service for works in the local computer.

### BACKGROUND OF THE INVENTION

1. Field of the Invention

The present invention relates to a data security system, apparatus and method, and more particularly, to a data security system, apparatus and method using a USB device, which is capable of providing data security by processing data based on authentication of the USB device.

2. Description of the Related Art

Internet has had a tremendous effect on our life, and with rapid development of information and telecommunication technology, many efforts have been made to provide various kinds of useful information for us at higher speed and with greater precision. The Internet, being a reservoir of information, has an enormous number of cyber spaces, being called “web site,” in which numerous kinds of materials are contained. Spread of information through the Internet has been accelerated with development of various kinds of communication networks.

However, although the fast-growing Internet allows us to acquire a large amount of information with ease, it is always vulnerable to hackers' attack.

At present, various kinds of hacking techniques have spread all over the world, and security techniques against such hacking techniques have been devised. Whenever the hacking techniques defeat the security techniques, accompanying damages to Internet users have spread.

In addition, when confidential documents of companies are leaked out of the companies due to carelessness of users or by ill-intentioned users, the companies may be confronted with a crisis. Such leakage of information not only deals a serious blow to the companies, but also weakens their competitive power. Thus, some companies tighten security by strictly controlling the flow of storage media in and out of the companies, which costs them a substantial amount of money.

FIG. 1 is a view showing an information leakage path in a general network. Referring to FIG. 1, important company information made in a company may be leaked out via various paths.

For example, data made in a local computer 100 in the company may be leaked out by a hacker who accesses 110 the local computer 100 through a network. Also, the data may be leaked out through a web site 120 of a cooperating company connected to the company via Internet. Furthermore, an employee of the company may leak out information and documents directly or by illegally using a name of a document manager.

While the hacking technique is being developed day by day, information and system protection techniques using password authentication have a limitation on their verification and spread.

Accordingly, there is a keen need for an effective method to maintain information security through authentication for works in networked local computers.

### SUMMARY OF THE INVENTION

Accordingly, it is an object of the present invention to provide a data security system, apparatus and method using a USB device, which is capable of maintaining document security by connecting a USB device to a local computer, automatically installing an automatic installation program stored in the USB device in the local computer, and coding and storing documents made by a user according to the automatically installed program.

It is another object of the present invention to provide a data security system, apparatus and method using a USB device, which is capable of maintaining document security by connecting a USB device to a local computer, automatically installing an automatic installation program stored in the USB device in the local computer, and capturing and storing a work screen on which a user works with a document according to the automatically installed program.

It is still another object of the present invention to provide a data security system, apparatus and method using a USB device, which is capable of maintaining document security by connecting a USB device to a local computer, automatically installing an automatic installation program stored in the USB device in the local computer, capturing a work screen on which a user works with a document, and transmitting the captured work screen to a server according to the automatically installed program.

It is still another object of the present invention to provide a data security system, apparatus and method using a USB device, which is capable of maintaining document security by connecting a USB device to a local computer, automatically installing an automatic installation program stored in the USB device in the local computer, and transmitting use history of the local computer to a server when a user works with a document according to the automatically installed program.

It is still another object of the present invention to provide a data security system, apparatus and method using a USB device, which is capable of maintaining document security by connecting a USB device to a local computer, automatically installing an automatic installation program stored in the USB device in the local computer, and controlling output of a monitor connected to the local computer when a user works with a document according to the automatically installed program.

It is still another object of the present invention to provide a data security system, apparatus and method using a USB device connected to a local computer and including a fingerprint recognition means, which is capable of performing an authentication function through the fingerprint recognition means.

It is still another object of the present invention to provide a data security system, apparatus and method using a USB device connected to a local computer and including an RF module, which is capable of using the USB device to allow a user to come in and go out a building.

To achieve the above objects, according to an aspect, the present invention provides a data security system using a USB device for maintaining security for files made while various kinds of application programs are used, comprising: a local computer having the various kinds of application programs installed therein and performing various works by executing the installed various kinds of application programs; and a USB device connected to the local computer via a USB communicating means, wherein, when the USB device is connected to the local computer, a security program is automatically installed from the USB device into the local computer, and the automatically-installed security program performs a security service for works in the local computer.

Preferably, the data security system further comprises a management server for receiving work-related information via a network after completion of authentication through the security program installed from the USB device.

Preferably, the data security system further comprises a remote computer remotely connected to the local computer via a network, the remote computer monitoring a work situation of the local computer and controlling the local computer remotely.

Preferably, the security program automatically installed in the local computer requests the USB device to provide authentication information to the local computer and authenticates the works in the local computer when the local computer receives the authentication information from the USB device.

Preferably, the authentication information comprises user fingerprint information input through a fingerprint authentication means included in the USB device.

Preferably, if the authentication through the USB device is not normally performed, an output signal of a monitor is interrupted by the security program automatically installed in the local computer.

Preferably, the security program automatically installed in the local computer codes and stores the files made in the process of work through the various kinds of application programs executed in the local computer.

Preferably, the security program automatically installed in the local computer decodes the files coded and stored in the local computer in order to allow a user to read the files.

Preferably, the security program automatically installed in the local computer generates work history information in the process of work through the various kinds of application programs executed in the local computer and transmits the generated work history information to a management server connected to a network.

Preferably, the USB device includes an RF module to perform authentication through RF communication, the RF module being used for an admission ticket of a building.

According to another aspect, the present invention provides a data security apparatus for maintaining security for files made while an application program installed in a local computer is used, comprising: a first storing part that stores an automatic execution program to be automatically installed in the local computer when the data security apparatus is connected to the local computer; a port that provides a connecting point between the data security apparatus and the local computer; a USB hub that includes a switching function for communication connection control for controlling connection between the data security apparatus and the local computer; a virtual CD-ROM driver that controls the data security device to be recognized as a virtual CD-ROM device when the data security device is connected to the local computer; and a first controller that is connected to the local computer through the USB hub and drives the virtual CD-ROM driver to control the local computer to recognize the data security apparatus as the virtual CD-ROM device.

Preferably, the data security apparatus further comprises a second storing part that stores an image captured and compressed when work is performed in the local computer.

Preferably, the first storing part and the second storing part are used as two regions into which one memory is divided.

Preferably, the automatic execution program automatically installed in the local computer requests the data security apparatus to provide authentication information to the local computer and authenticates work in the local computer when the local computer receives the authentication information from the data security apparatus.

Preferably, the data security apparatus further comprises a fingerprint authentication means that receives fingerprint information from a user and transmits the received fingerprint information to the local computer for user authentication.

Preferably, the data security apparatus further comprises an RF module to perform authentication through RF communication, the RF model being used for an admission ticket of a building.

According to still another aspect, the present invention provides a data security method for maintaining security for files made while an application program installed in a local computer is used, comprising the steps of: connecting a USB device to the local computer and receiving at the local computer an automatic execution program from the USB device; automatically installing and executing the received automatic execution program in the local computer; requesting a user to input user fingerprint information and authenticating the user based on the input user fingerprint information; after completion of the authentication, executing the application program installed in the local computer and performing a work in the local computer; and coding and storing the files made in the work according to the automatic execution program automatically installed in the local computer.

Preferably, the data security method further comprises the steps of: capturing a work screen in the process of work according to the automatic execution program; and compressing and storing the captured work screen.

Preferably, the data security method further comprises the step of: after the step of storing the captured work screen, transmitting the compressed and stored work screen to a management server connected to the local computer via a network.

Preferably, the data security method further comprises the step of: after the step of storing the captured work screen, transmitting the compressed and stored work screen to the USB device connected to the local computer through USB communication means.

Preferably, the data security method further comprises the steps of: generating and storing work history information in the process of work according to the automatic execution program; and transmitting the generated and stored work history information to a management server connected to the local computer via a network.

Preferably, the automatic execution program automatically installed in the local computer decodes the files coded and stored in the local computer in order to allow the user to read the files.

Preferably, if the authentication through the USB device is not normally performed, an output signal of a monitor is interrupted by the automatic execution program automatically installed in the local computer.

The present invention suggests a method of maintaining security of work files (for example, document files) when a user executes an application program in a local computer connected to a network to perform a work. To this end, the present invention provides various additional functions as well as security of the work files using a USB (Universal Serial Bus) device.

Specifically, when the USB device is connected to the local computer, an automatic installation program stored in the USB device is automatically installed in the local computer to provide the security and the various additional functions to the local computer.

The automatic installation program includes a program for coding and decoding files contained in a Window kernel. This program allows files made in the local computer to be automatically coded and stored in the Window kernel and allows the stored files to be decoded when a user tries to open and see the stored files.

In addition, the automatic installation program includes a program for capturing and storing a work screen of the local computer. This program monitors an operation of an application program executed in the local computer and captures and stores the work screen of the local computer so that a work history of a user can be checked. The captured and stored work screen may be transmitted to a server connected to a network so that a manager can monitor works of the user.

In addition, the automatic installation program includes a program for transmitting a use history of a user in the local computer to a server connected to a network. Thus, this program allows a manager who operates the server to monitor the use history of the user.

In addition, the automatic installation program includes a program for controlling output of a monitor connected to the local computer depending on whether or not the USB device authenticates a user. This program may prevent an unauthorized person from using the local computer by restricting output of the monitor connected to the local computer depending on the authentication for the user.

The above-mentioned various programs automatically installed in the local computer by the USB device may be automatically updated by a management server through a network (for example, Internet).

In addition, the USB device includes a fingerprint recognition means performing an authentication function, which is capable of preventing an unauthorized person or a person who illegally takes the USB device from accessing the local computer. In addition, the USB device includes an RF module by means of which the USB device may be used to allow a user to come in and go out a building.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a view showing an information leakage path in a general network;

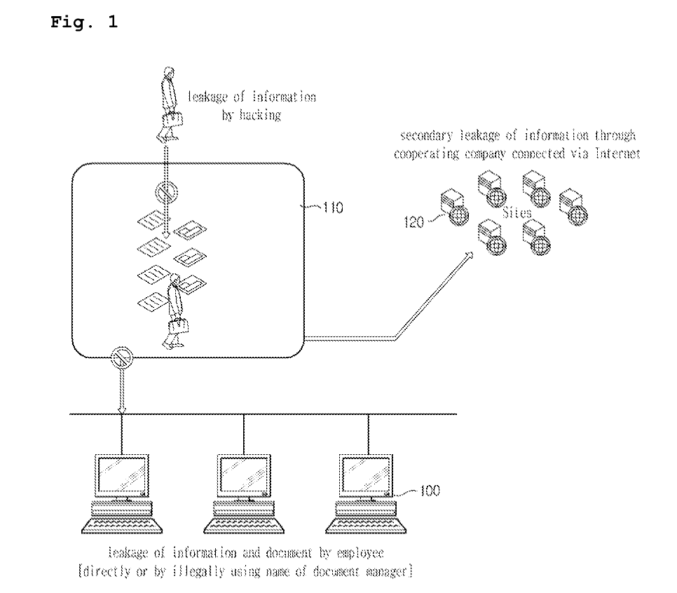

FIG. 2 is a view illustrating a data security system using a USB device according to an embodiment of the present invention;

FIG. 3 is a view illustrating a detailed configuration of a local computer according to an embodiment of the present invention;

FIG. 4 is a view illustrating a detailed configuration of a USB device according to an embodiment of the present invention;

FIG. 5 is a plan view of a USB device according to an embodiment of the present invention;

FIG. 6 is a flow chart illustrating an operation of a data security system using a USB device according to an embodiment of the present invention; and

FIG. 7 is a view illustrating a data authentication service according to an embodiment of the present invention.

### DETAILED DESCRIPTION OF THE PREFERRED EMBODIMENT

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention.

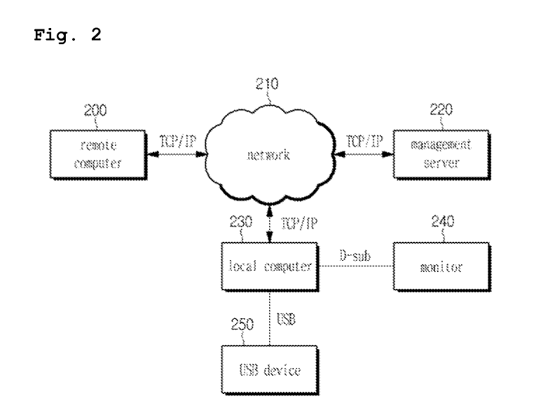

First, detailed configuration of a system and a device according to an embodiment of the present invention will be described with reference to FIGS. 2 to 4.

FIG. 2 is a view illustrating a data security system using a USB device according to an embodiment of the present invention. Referring to FIG. 2, a data security system using a USB device according to an embodiment of the present invention may comprise a remote computer 200, a network 210, a management server 220, a local computer 230, a monitor 240 and a USB device 250.

Various application programs (for example, a word processor, a graphic tool, a spread sheet are installed in the local computer 200, and a user executes the application programs installed in the local computer 230 to perform various works.

The local computer 230 is connected to the monitor 240 by a cable line such as D-sub, and work situation in the local computer 230 is displayed on the monitor 240. Also, the local computer 230 communicates with the remote computer 200 or the management server 220 via the network 210 by TCP/IP (Transmission Control Protocol/Internet Protocol).

When the USB device 250 is connected to the local computer 230 by a USB communication means, various programs stored in the USB device 250 are automatically installed in the local computer 230, and then, the automatically-installed programs perform various data securities when the user performs works using the local computer 230.

Specifically, when the user executes an application program to perform a work, files which are being made through the work are coded and stored in a kernel. The coded files can be decoded and readable only when the USB device 250 is connected to the local computer 230 to perform normal authentication.

In addition, when the user performs the work using the local computer 230, the programs automatically installed in the local computer 230 monitors operations of the application programs executed in the local computer 230, and captures and stored a work screen of the local computer 230. At this time, the captured and stored work screen may be transmitted to the management server 220 via the network 210 so that a manager can watch the work of the user.

In addition to the work screen, a work history may be stored and transmitted to the management server 220 via the network 210 so that the manager can know a work situation of the user who uses the local computer 230.

Specifically, in the management server 220 are stored user authentication information of the local computer 230 for documents and contents, chief use history information of the user who accesses the local computer 230, capture information of the local computer 230, fingerprint information of the user, etc. to provide various functions of the present invention.

In the mean time, the remote computer 200 may access the local computer 230 via the network 210 to check works performed in the local computer 210 or files stored in the local computer 230.

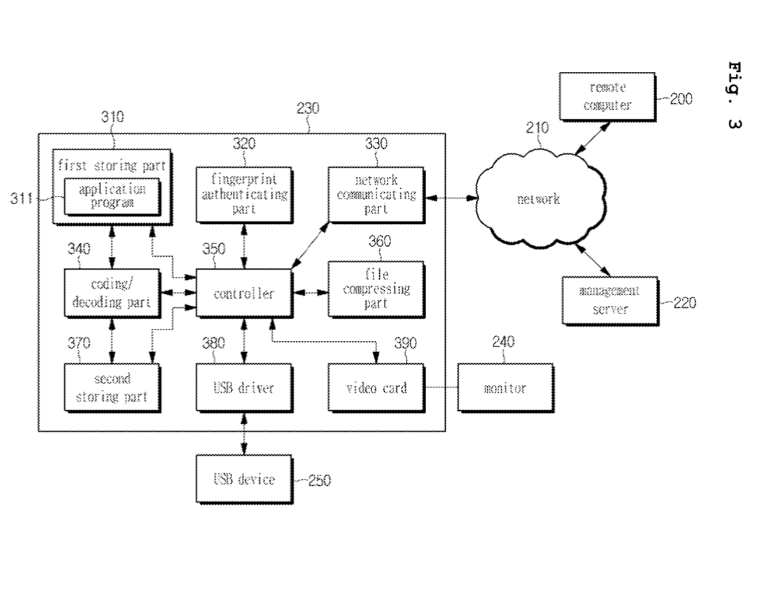

FIG. 3 is a view illustrating a detailed configuration of the local computer 230 according to an embodiment of the present invention. Referring to FIG. 3, the local computer 230 may comprise a first storing part 310, a fingerprint authenticating part 320, a network communicating part 330, a coding/decoding part 340, a controller 350, a file compressing part 360, a second storing part 370, a USB driver 380, a video card 390, etc.

When the local computer 230 is connected to the USB device 250 via the USB driver 380, an automatic execution program stored in the USB device 250 is transmitted to the local computer 230 via the USB driver 380 and automatically installed in the local computer 230. Then, the automatically-installed program creates the fingerprint authenticating part 320, the network communicating part 330, the coding/decoding part 340, the file compressing part 360, etc.

When fingerprint recognition information is transmitted to the local computer 230 through a fingerprint recognizing part of the USB device 250, the fingerprint recognition information is provided to the fingerprint authenticating part 320 of the local computer 230 through the controller 350 and the fingerprint authenticating part 320 performs authentication for a user based on the fingerprint recognition information.

After completion of the authentication, when an application program 311 stored in the first storing part 310 is executed, the controller 350 codes files made in the execution of the application program through the coding/decoding part 340 and stores the coded files in the second storing part 370.

In addition, the controller 350 monitors operation of the application program 311, captures an image output to the monitor 240 through the video card 390, and stores the captured image in the second storing part 370. In this case, the captured image is compressed by the file compressing part 360 and then stored in the second storing part 370. The compressed image may be transmitted to the management server 220 through the network communicating part 330 and the network 210. In addition, the controller 350 monitors a use history of the user in the local compute 230 and transmits the use history to the management server 220 through the network communicating part 330 and the network 210.

The remote computer 200 controls the local computer 230 remotely through network 210 and the network communicating part 330 or monitors a work situation of the user who uses the local computer 230.

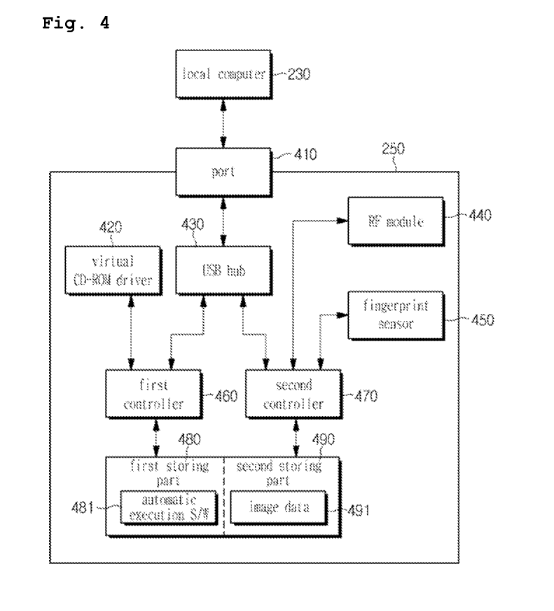

FIG. 4 is a view illustrating a detailed configuration of the USB device 250 according to an embodiment of the present invention. Referring to FIG. 4, the USB device 250 may comprise a port 410, a virtual CD-ROM device 420, a USB hub 430, an RF module 440, a fingerprint sensor 450, a first controller 460, a second controller 470, a first storing part 480, a second storing part 490, etc. In this embodiment, the USB device 250 may have a form of dongle.

As shown in FIG. 4, the first storing part 480 and the second storing part 490 may be used as two regions into which one memory (for example, a flash memory) is divided. When the USB device 250 is connected to the local computer 230, an automatic execution software 481 to be automatically installed is stored in the first storing part 480 and an image captured when a user works in the local computer 230 is compressed and stored as an image data 491 in the second storing part 490.

The port 410 is provided as a connection point between the USB device 250 and the local computer 230. The USB hub 430 controls connection between a main connection device (i.e., the local computer 230) and a sub connection device (i.e., the USB device 250) and has a USB hub function or a switching function for control of communication connection. In other words, the USB hub 430 controls communication between the local computer 230 and the first controller 460 or the second controller 470.

First, when the USB device 250 is connected to the local computer 230 via the port 410, the USB hub 430 connects the local computer 230 to the first controller 460, drives the virtual CD-ROM driver 420, and controls the local computer 230 to recognize the USB device 250 as a virtual CD-ROM device.

At this time, in the USB device 250 recognized as the virtual CD-ROM device, the automatic execution software 481 stored in the first storing part 480 is automatically executed and installed in the local computer 230. Various security-related functions of the present invention are performed by the automatic execution software 481 automatically installed in the local computer 230.

After the automatic execution software 481 is installed in the local computer 230, user authentication can be performed through the fingerprint sensor 450 of the USB device 250. Specifically, the user inputs his/her fingerprint through the fingerprint sensor 450 and information on the input fingerprint is transmitted to the local computer 230 through the second controller 470, the USB hub 430 and the port 410. As described with reference to FIG. 3, the fingerprint authenticating part 320 of the local computer 230 performs the user authentication based on the transmitted fingerprint information. Alternatively, the fingerprint information may be transmitted to the management server 220 via the network 210 and user authentication may be performed by the management server 220.

The automatic execution software 481 automatically executed in the local computer 230 may include an algorithm to code and decode documents contained in a Window kernel and made by the user, a function to capture, compress and store a picture displayed on the local computer 230, a function to decode and reproduce the stored picture and transmit the stored picture to the management server 220, a function to transmit a chief use history of the local computer 230 to the management server 220, a function to switch on/off the monitor 240 depending on whether or not the USB device 250 is connected to the local computer 230, a function to set the right to communicate with the management server 220, etc.

The RF module 440 performs an RF communication function to allow the user to come in and go out a building when the USB device 250 is used for an admission ticket. The RF module 440 may comprise an RF antenna and a memory.

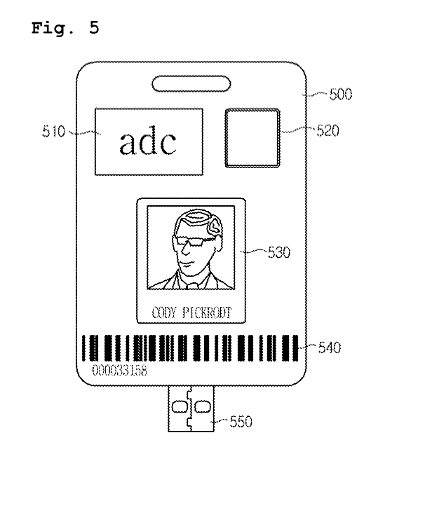

FIG. 5 is a plan view of a USB device according to an embodiment of the present invention. Referring to FIG. 5, a USB device 500 can be used for authentication and an admission ticket of a company, as described above.

Specifically, in order to use the USB device 500 as the admission ticket, a company's name 510, a user's photograph 530, a bar code 540, etc. can be printed on a surface of the USB device 500. In addition, as described above, in the USB device 500 is contained the RF module 440 to authenticate a user who comes in and goes out of a company.

In addition, on the surface of the USB device 500 is further provided a fingerprint identifying part 520 through which fingerprint information of the user is input. In addition, the USB device 500 further includes a USB connector 550 to connect the USB device 500 to the local computer 230 for USB communication therebetween.

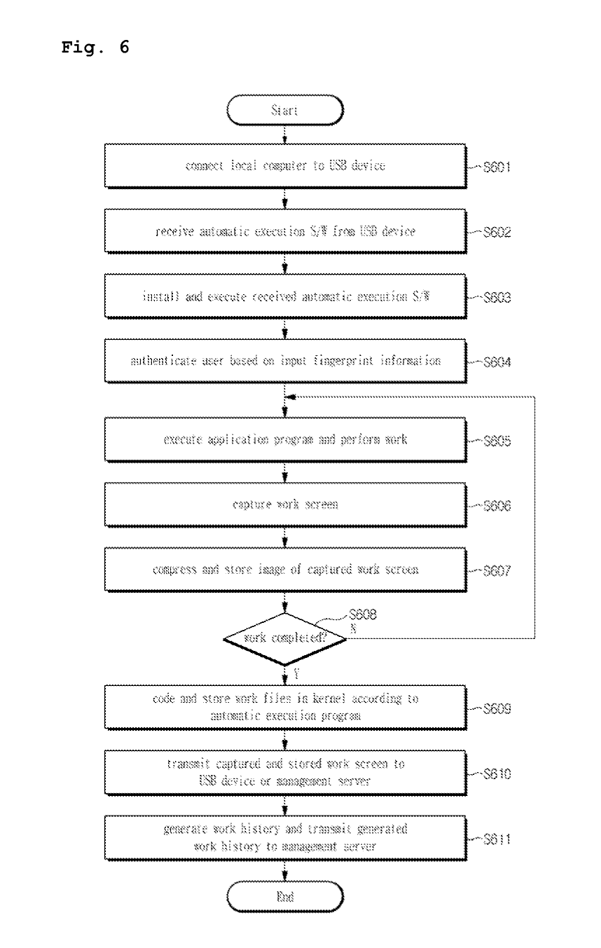

FIG. 6 is a flow chart illustrating an operation of the data security system using the USB device according to an embodiment of the present invention. Referring to FIG. 6, first, when the USB device 250 is connected to the local computer 230 at Step S601, the local computer 230 receives an automatic execution software from the USB device 250 at Step S602. Then, the local computer 230 automatically installs and executes the received automatic execution software at Step S603 and authenticates a user based on fingerprint information input from the user at Step S604.

After completion of the authentication, the user executes an application program in the local computer 230 to perform a work at Step S605. Then, a work screen on which the user works is captured at Step S606, and the captured work screen is compressed and stored at Step S607.

After completion of the work at Step S608, work-related files are coded and stored by the automatically-installed software at Step S609. The coded and stored files can be decoded to be readable through justified authentication or by an operator of the management server 220.

Then, the captured and stored work screen is transmitted to the USB device 250 or the management server 220 via the network 210 at Step S610. In addition, a work management history is stored and transmitted to the management server 220 via the network 210 at Step S611.

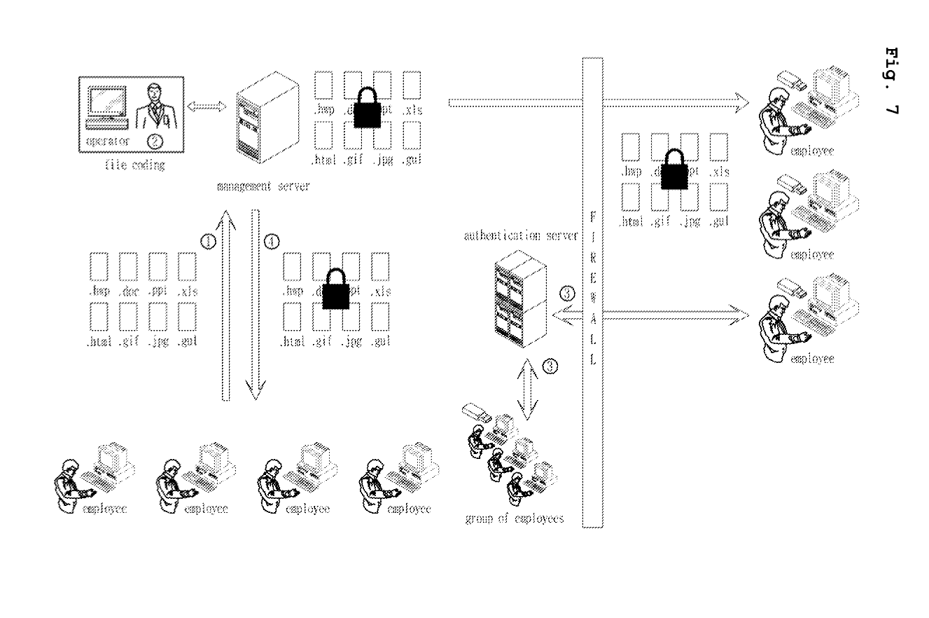

FIG. 7 is a view illustrating a data authentication service according to an embodiment of the present invention. Referring to FIG. 7, when an employee of a company uploads files into a management server of the company ((\textcircled{1})), a manager codes ((\textcircled{2})) and stores the uploaded files collectively to maintain security.

In addition, in order that the employee works in the company or outside the company, he/she has to be authenticated ((\textcircled{3})) through an authentication server by inserting the USB device of the present invention in his/her local computer.

In addition, the files coded and stored in the management server can be decoded and used ((\textcircled{4})) only after being authenticated by inserting the USB device in the local computer. If the USB device inserted in the local computer is removed or justified authentication is not performed, the files are not readable and stored and a picture to be output to the monitor is restricted, thereby providing thorough security for work files or confidential documents of the company.

In addition, by transmitting the log (i.e., work history) or the captured screen of the work done at the local computer to the management server, security accidents, if any, can be tracked.

As apparent from the above description, according to the present invention, by allowing a user to work in a local computer only when he/she connects a USB device, which contains a program to be automatically installed in the local computer, to the local computer and is justly authenticated, security for documents of a company can be maintained.

In addition, by capturing a work situation in the local computer, storing the captured work situation as an image, and automatically informing a management server of a work history, a cause of a security accident, if it takes place, can be tracked.

Furthermore, if a user is not justly authenticated through the USB device, he/she can not access coded documents stored in a company and output of the documents to a monitor is restricted, thereby maintaining security for the documents effectively.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A data security system using a USB device for maintaining security for files made while various kinds of application programs are used, comprising:
a local computer having the various kinds of application programs installed therein and performing various works by executing the installed various kinds of application programs; and
a USB device connected to the local computer via a USB communicating means, wherein, when the USB device is connected to the local computer, a security program is automatically installed from the USB device into the local computer, and the automatically-installed security program performs a security service for works in the local computer.

2. The data security system according to claim 1, further comprising a management server for receiving work-related information via a network after completion of authentication through the security program installed from the USB device.

3. The data security system according to claim 1, further comprising a remote computer remotely connected to the local computer via a network, the remote computer monitoring a work situation of the local computer and controlling the local computer remotely.

4. The data security system according to claim 1, wherein the security program automatically installed in the local computer requests the USB device to provide authentication information to the local computer and authenticates the works in the local computer when the local computer receives the authentication information from the USB device.

5. The data security system according to claim 4, wherein the authentication information comprises user fingerprint information input through a fingerprint authentication means included in the USB device.

6. The data security system according to claim 4, wherein, if the authentication through the USB device is not normally performed, an output signal of a monitor is interrupted by the security program automatically installed in the local computer.

7. The data security system according to claim 1, wherein the security program automatically installed in the local computer codes and stores the files made in the process of work through the various kinds of application programs executed in the local computer.

8. The data security system according to claim 7, wherein the security program automatically installed in the local computer decodes the files coded and stored in the local computer in order to allow a user to read the files.

9. The data security system according to claim 1, wherein the security program automatically installed in the local computer generates work history information in the process of work through the various kinds of application programs executed in the local computer and transmits the generated work history information to a management server connected to a network.

10. The data security system according to claim 1, wherein the USB device includes an RF module to perform authentication through RF communication, the RF module being used for an admission ticket of a building.

11. A data security apparatus for maintaining security for files made while an application program installed in a local computer is used, comprising:
a first storing part that stores an automatic execution program to be automatically installed in the local computer when the data security apparatus is connected to the local computer;
a port that provides a connecting point between the data security apparatus and the local computer;
a USB hub that includes a switching function for communication connection control for controlling connection between the data security apparatus and the local computer;
a virtual CD-ROM driver that controls the data security device to be recognized as a virtual CD-ROM device when the data security device is connected to the local computer; and
a first controller that is connected to the local computer through the USB hub and drives the virtual CD-ROM driver to control the local computer to recognize the data security apparatus as the virtual CD-ROM device.

12. The data security apparatus according to claim 11, further comprising a second storing part that stores an image captured and compressed when work is performed in the local computer.

13. The data security apparatus according to claim 12, wherein the first storing part and the second storing part are used as two regions into which one memory is divided.

14. The data security apparatus according to claim 11, wherein the automatic execution program automatically installed in the local computer requests the data security apparatus to provide authentication information to the local computer and authenticates work in the local computer when the local computer receives the authentication information from the data security apparatus.

15. The data security apparatus according to claim 14, further comprising a fingerprint authentication means that receives fingerprint information from a user and transmits the received fingerprint information to the local computer for user authentication.

16. The data security apparatus according to claim 14, wherein, if the authentication through the data security apparatus is not normally performed, an output signal of a monitor is interrupted by the automatic execution program automatically installed in the local computer.

17. The data security apparatus according to claim 11, wherein the automatic execution program automatically installed in the local computer codes and stores the files made in the process of work through the application program executed in the local computer.

18. The data security apparatus according to claim 17, wherein the automatic execution program automatically installed in the local computer decodes the files coded and stored in the local computer in order to allow the user to read the files.

19. The data security apparatus according to claim 11, wherein the automatic execution program automatically installed in the local computer generates work history information in the process of work through the application program executed in the local computer and transmits the generated work history information to a management server connected to the local computer via a network.

20. The data security apparatus according to claim 11, further comprising an RF module to perform authentication through RF communication, the RF model being used for an admission ticket of a building.

21. A data security method for maintaining security for files made while an application program installed in a local computer is used, comprising the steps of:
connecting a USB device to the local computer and receiving at the local computer an automatic execution program from the USB device;
automatically installing and executing the received automatic execution program in the local computer;
requesting a user to input user fingerprint information and authenticating the user based on the input user fingerprint information;
after completion of the authentication, executing the application program installed in the local computer and performing a work in the local computer; and
coding and storing the files made in the work according to the automatic execution program automatically installed in the local computer.

22. The data security method according to claim 21, further comprising the steps of:
capturing a work screen in the process of work according to the automatic execution program; and
compressing and storing the captured work screen.

23. The data security method according to claim 22, further comprising the step of:
after the step of storing the captured work screen, transmitting the compressed and stored work screen to a management server connected to the local computer via a network.

24. The data security method according to claim 22, further comprising the step of:
after the step of storing the captured work screen, transmitting the compressed and stored work screen to the USB device connected to the local computer through USB communication means.

25. The data security method according to claim 21, further comprising the steps of:
generating and storing work history information in the process of work according to the automatic execution program; and
transmitting the generated and stored work history information to a management server connected to the local computer via a network.

26. The data security method according to claim 21, wherein the automatic execution program automatically installed in the local computer decodes the files coded and stored in the local computer in order to allow the user to read the files.

27. The data security method according to claim 21, wherein, if the authentication through the USB device is not normally performed, an output signal of a monitor is interrupted by the automatic execution program automatically installed in the local computer.
